(19) United States
(12) Patent Application Publication
(10) Pub. No.: US 2008/0240841 A1
(43) Pub. Date: Oct. 2, 2008

(54) Fluid dispensing apparatus

(75) Inventors: Paul Katz, New York, NY (US); Goeran Jerstroem, Glen Ridge, NJ (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 11/729,337

(22) Filed: Mar. 28, 2007

(51) Int. Cl. B43K 5/02; A46B 11/02

(52) U.S. Cl. 401/188 R; 401/146

(57) ABSTRACT

An apparatus for dispensing fluid, such as soap for washing items such as dishes and the like, is disclosed having a piston mechanism with a seal between a piston head and cylinder. The apparatus may include a one-way valve to prevent fluid from entering a soap storage reservoir. The apparatus may include a sponge head portion for scrubbing the items, for instance, and for receiving soap dispensed by the apparatus.

### FIELD OF THE INVENTION

The invention relates to a device for dispensing fluid and, in one particular form, to an apparatus with a reservoir and pump for dispensing fluid and, in some forms, having a valve for preventing reverse flow into the reservoir.

### BACKGROUND

Currently, many devices are known for washing dishes that are adapted to provide soap directly from the device. For instance, a commonly used device includes a working end, such as an end that is held distally and having a sponge thereon for scrubbing or scouring dishes and the like, and includes a handle having a reservoir for storing dishwashing soap or detergent in liquid form. Typically, the handle has a screw cap for accessing the reservoir for filling the same with the liquid soap. The device utilizes simple gravity so that, when the handle is held with the cap end upward and the sponge downward, the soap seeps into the sponge from the reservoir.

There are a number of deficiencies in such a system. Principally, these devices do not prevent fluid from being drawn into the reservoir via the soap dispensing opening. More specifically, the reservoir has an opening through which soap is forced into the sponge. This reservoir opening can, if immersed in dishwater, for instance, allow the water to enter the reservoir. The result is that the soap becomes diluted and lowers its viscosity so that it flows too readily from the reservoir. This results in wasting the soap.

Heretofore, the only manner for addressing this issue has been to reduce the opening so that any flow rate therethrough allows soap to be dispensed but only permits a small amount of fluid to pass in a reverse direction. Accordingly, there has been a need for an improved soap-dispensing device for washing dishes.

Additionally, turkey basters, eye-droppers, and other devices having a compressible bulb for drawing in and forcing out fluid therefrom are known. In operation, the bulb is compressed a first time and the tip of the device is submerged in fluid. This serves to evacuate the bulb and the device. As the bulb is released, it expands to produce a vacuum or suction to draw the fluid into the bulb and device. It is difficult to compress the bulb entirely, particularly with one hand, so that air usually remains in the bulb. In order to use a device with air remaining therein, the device must be pointed generally downwardly so the heavier fluid is at the tip opening while the air is in the bulb. More importantly, these devices have openings, as described above, that allow the fluid to flow out if not maintained with the tip upward, albeit slowly when the fluid therein is highly viscous. Accordingly, there has been a need for an improved fluid dispensing device.

### SUMMARY

In accordance with an aspect of the present invention, a fluid-dispensing apparatus is disclosed including an elongated portion including a cavity for storing cleaning fluid therewithin, a cleaning medium carried by the body, an opening in the body providing communication between the cavity and the cleaning medium, an actuator mechanism for moving cleaning fluid from the cavity through the opening to the cleaning medium, and a valve disposed at the opening and having an open position for permitting cleaning fluid to flow from the cavity through the opening and having a closed position for preventing fluid flow into the cavity through the opening.

The body may include a handle, the cavity being formed in the handle. The actuator mechanism may include a pump assembly. The pump assembly may include a piston moveable from a retracted position toward the opening to force soap from the cavity through the opening. The pump assembly may further include a return-bias member for returning the piston toward the retracted position. The pump assembly may include a compressible pump bulb depressible to advance the piston from the retracted position toward the opening.

The cleaning medium may include a sponge portion. The body may include an elongated extending portion received within the cleaning medium. The valve may be located within the elongated extending portion, the elongated extending portion including the opening for permitting cleaning fluid to be dispensed and having an inlet in communication with the cavity for storing cleaning fluid, the valve being assembled with the elongated portion by insertion through the inlet. The opening may be closely positioned to the valve, and the opening may be closely positioned to at least a portion of the cleaning medium. The cleaning medium may include a brush portion. The cleaning medium may be removably secured with the body.

The actuator mechanism may be removable to provide access to the cavity for filling the cavity with cleaning fluid to be dispensed. The valve may automatically close when the actuator mechanism is released. The valve may automatically close when the pressure within the cavity is no greater than the atmospheric pressure outside of the apparatus.

The body may include a valve-receiving portion which includes the opening for permitting cleaning fluid to be dispensed and has an inlet in communication with the cavity for storing cleaning fluid, the valve being located within the valve-receiving portion, and the valve-receiving portion being assembled with the valve by insertion through the inlet.

In another aspect, an apparatus for dispensing fluid is disclosed including an elongated body portion including a cavity for receiving fluid therein, an opening in communication with the cavity for permitting the received fluid to be dispensed therefrom, and an actuator mechanism including a piston cylinder, and a piston having a peripheral seal in contact with the piston cylinder, the piston movable in a first direction for directing fluid from the cavity through the opening and movable in a second direction opposite the first direction for drawing fluid into the cavity through the opening. The apparatus may including a resilient compressible pump bulb secured over the piston. The piston may include an extending portion manually actuatable, the pump bulb covering the extending portion.

### BRIEF DESCRIPTION OF THE DRAWINGS

FIG. 1 is a perspective view of an embodiment of a pump-actuated fluid-dispensing apparatus in accordance with the present invention;

FIG. 2 is a cross-sectional view of the apparatus of FIG. 1;

FIG. 3 is a partially exploded perspective view of the apparatus of FIG. 1;

FIG. 4 is a perspective view of a sponge head assembly of the apparatus of FIG. 1;

FIG. 5 is a perspective view of a mounting clip of the sponge head assembly of FIG. 4;

FIG. 6 is a side elevational view of the mounting clip of FIG. 5;

FIG. 7 is a side elevational view of a handle body of the apparatus of FIG. 1;

FIG. 8 is a perspective view of a pump assembly of the apparatus of FIG. 1;

FIG. 9 is a perspective view similar to FIG. 8 with a pump bulb removed, a pump housing shown in phantom, and a pump subassembly shown within the pump housing;

FIG. 10. is a perspective view of the pump subassembly of FIG. 9;

FIG. 11 is a perspective view of a pump actuator of the pump subassembly of FIG. 10; and

FIG. 12 is a cross-sectional view of a portion of a valve assembly and an alternative form of a handle body assembled therewith.

### DETAILED DESCRIPTION

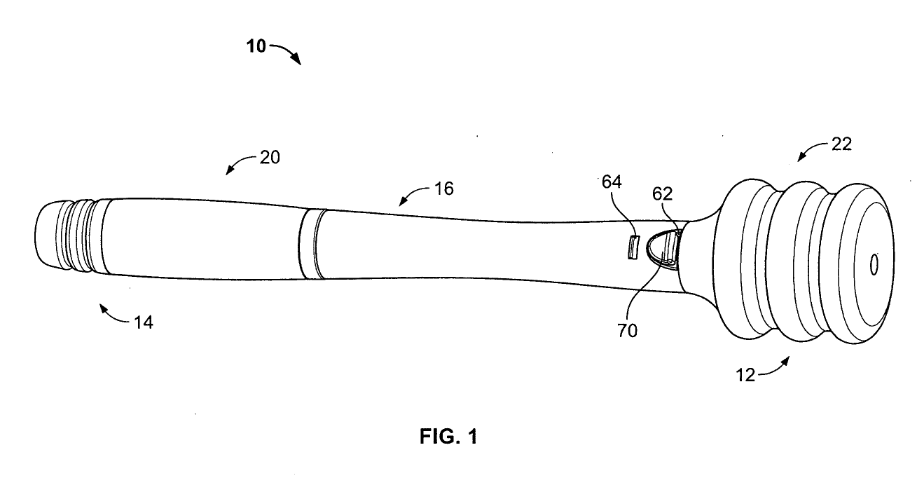

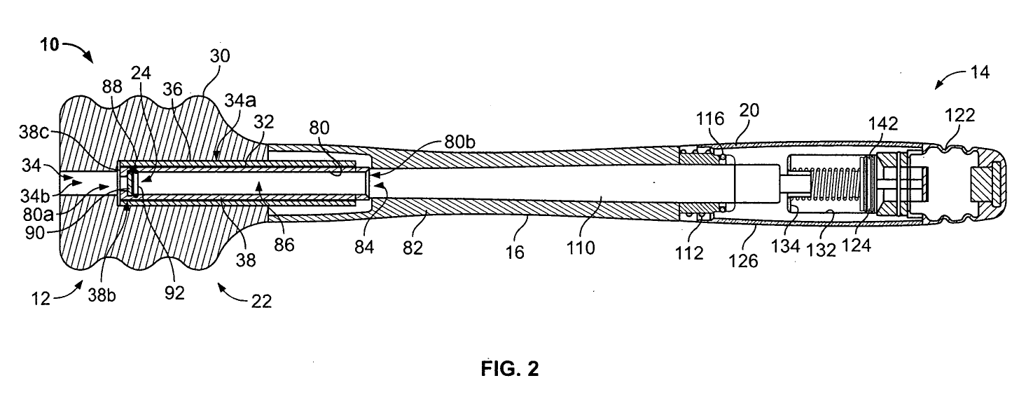

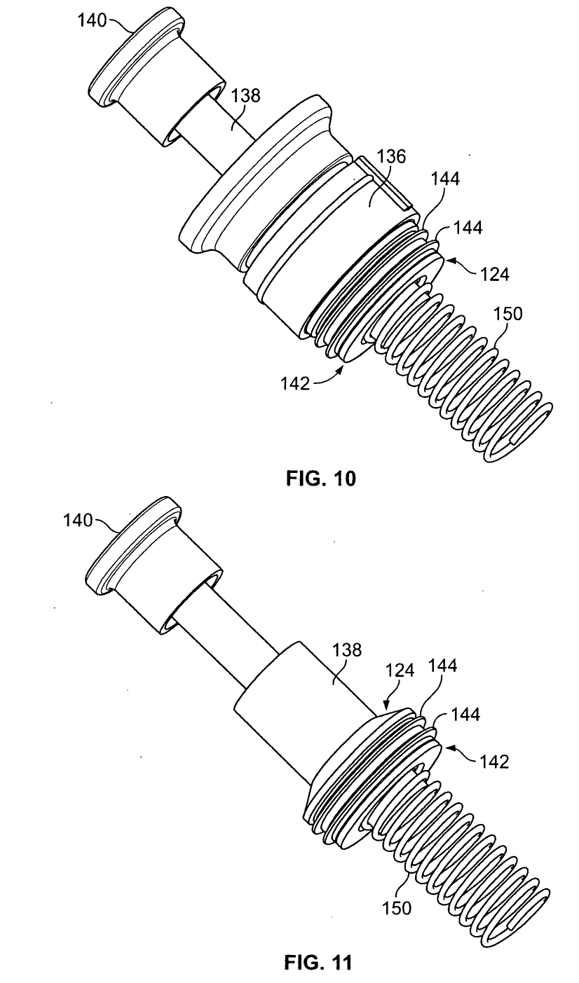

Referring initially to FIG. 1, a wand 10 is depicted. In one form, the wand 10 is a device for storing and dispensing cleaning fluid such as soap and has a distal end 12 for contacting items such as dishes or the like to be washed and having a proximal end 14 with a handle 16 extending between the ends 12, 14. As will be discussed, the wand 10 includes a pump assembly 20 (FIGS. 8-11) for forcing soap stored within the handle 16 into and through a head assembly 22 having a medium 30 such as a sponge or brush for use in washing dishes. In one form, the sponge head assembly 22 includes a one-way valve assembly 24 (FIG. 2). As will be discussed below, the valve assembly 24 allows fluid passage therethrough when the pump assembly 20 is actuated to open the valve assembly, yet retains fluid (such as the soap) within the wand 10 when the pump assembly 20 is not actuated.

In another form, the valve assembly 24 (and, in some forms, the sponge head assembly 22 as well) may be omitted such that operation of the pump assembly 20 serves to force fluid from the wand 10 by moving a piston 124 (see FIG. 2) in a first direction and to draw fluid (air or liquid) into the wand 10 by moving the piston 124 is a second direction opposite that of the first. The movement of the piston 124 is preferably spring-biased in the second direction, as will be discussed below. The second form may be advantageously utilized in a variety of manners include as a device for washing dishes, as a turkey baster, or as an eye-dropper type-device, as examples instance.

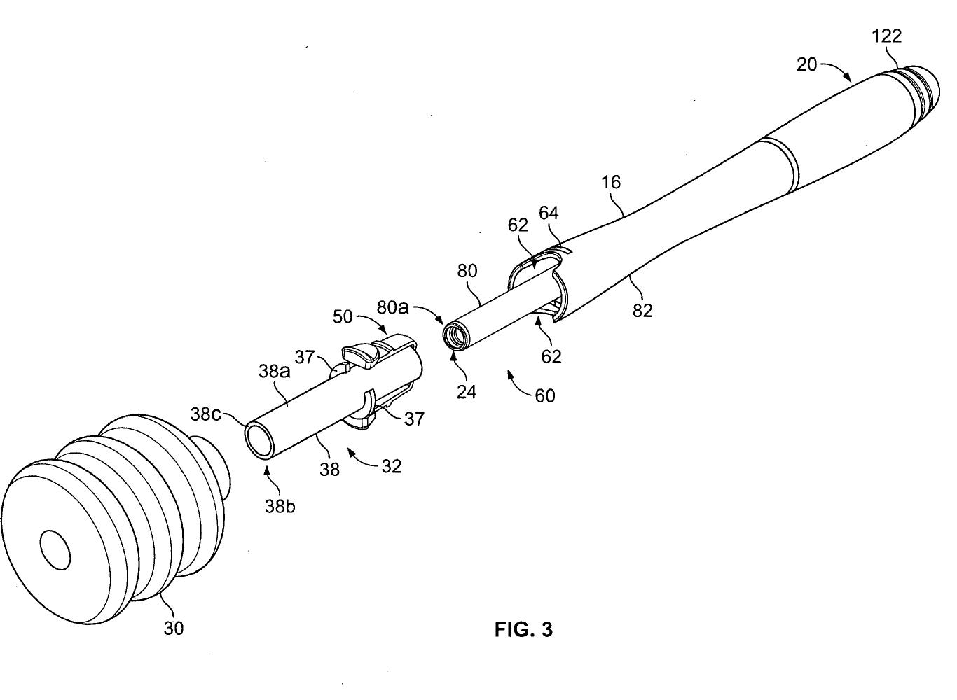

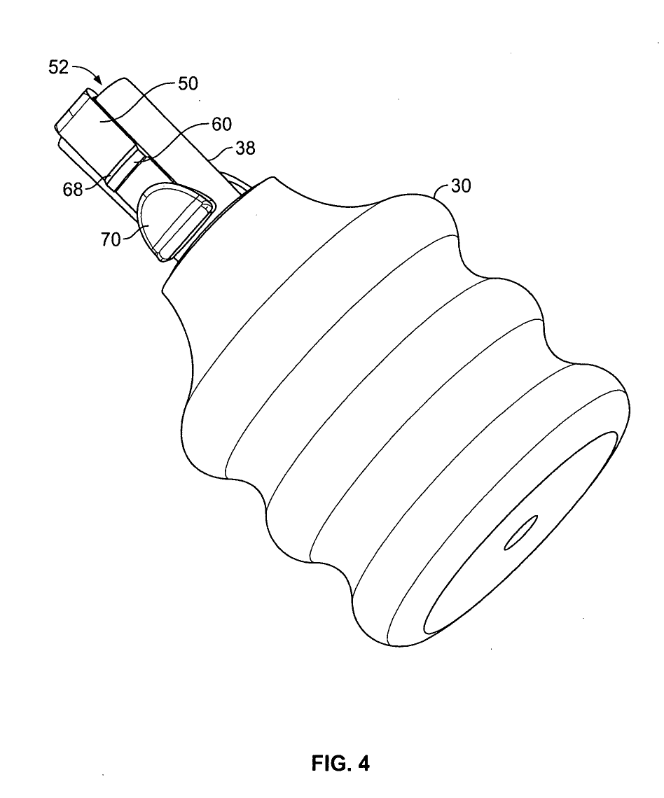

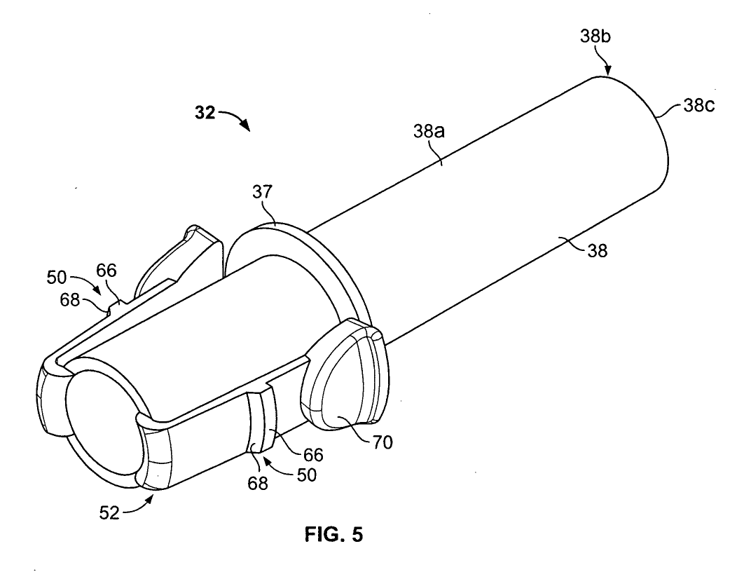

Turning now to FIGS. 2-6, the sponge head assembly 22 can be seen to include a medium 30 in the form of a sponge member and a mounting clip 32. The sponge member 30 includes a centrally located cavity 34 having a generally cylindrical shape. In a preferred form, the cavity 34 includes larger and smaller cavity portions 34a, 34b so that a shoulder 36 is formed therebetween. The mounting clip 32 includes an extended annular body portion 38, the exterior 38a of which fits snugly within the cavity 34. The body portion 38 has a distal end 38b that is inserted within the sponge cavity 34 so that a distal edge 38c thereof contacts the shoulder 36 to provide an indication of full receipt within the sponge 30. Additionally, the body portion 38 includes an annular ring or ring portions 37 (compare FIG. 3 with FIG. 5) which abut the sponge 30 when fully inserted therewith.

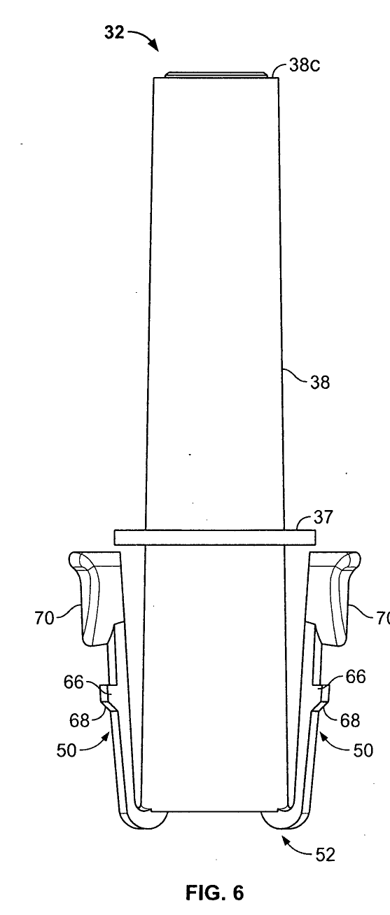

The body portion 38 is secured with the handle 16 for use. Towards this end, the mounting clip 32 includes a pair of deflectable fingers 50 that secure with the handle 16. The deflectable fingers 50 extend a short distance outwardly from a proximal end 52 of the body portion 38, and then extend distally along the exterior 38a of the body portion 38, angled slightly outwardly therefrom, as best seen in FIGS. 5 and 6.

The handle 16 includes structure that secures with the fingers 50. The handle 16 includes a distal end 60, best seen in FIG. 3, which receives the mounting clip body portion proximal end 52 therein. Notches 62 are formed on opposite sides of the handle distal end 60 which correspond to the fingers 50. Additionally, recesses or openings 64 are provided a short distance away from the notches 62. The fingers 50 include outwardly flaring tabs 66 that, when the mounting clip 32 is secured with the handle 16, are received within the recesses 64. As the mounting clip 32 is inserted into the handle 16, chamfer or ramp surfaces 68 formed on the tabs 66 contact the handle 16 so that the fingers 50 resiliently deflect inwardly. Once the tabs 66 reach the recesses 64, they return toward their natural position so that they move into the recesses 64. The fingers 50 also include grip surfaces 70 having an edge contoured to correspond with the shape of the notches 62 to provide a visual indication of proper alignment, the grip surfaces 70 themselves allowing for easy compression of the fingers 50 in order to remove the mounting clip 32 from the handle 16.

With reference to FIGS. 2 and 3, the handle 16 further includes an elongated cylindrical extension 80 received within the annular mounting clip body portion 38. The cylindrical extension 80 fits closely within the mounting clip body portion 38 to assist in resisting forces during use that might otherwise cause excessive stress on the cooperation between the finger tabs 66 and the handle recesses 64, as well as assist in proper alignment of the sponge head assembly 22 with the handle 16 during assembly.

As can be seen in FIG. 2, the extension 80 has a distal end 80a positioned proximate the distal end 38b of the mounting clip body portion 38. In this manner, fluid such as soap dispensed from the extension 80 is deposited into the sponge 30.

The extension 80 includes the afore-mentioned one-way valve assembly 24. In a preferred form, the extension 80 is assembled with a handle body portion 82 such as by ultrasonic welding. This allows the valve assembly 24 to be assembled into the extension 80 through a proximal opening 84 thereof. To be more specific, the extension 80 has a distal end 80a and a proximal end 80b with a central passageway 86 between the ends 80a, 80b to allow soap to flow therethrough, the proximal end 80b including the proximal opening 84 which forms an inlet into the passageway 86 from the handle 16, discussed in greater detail below. The extension 80 includes an internal shoulder 88 formed near the distal end 80a against which a valve member 90 is secured via a ring 92 or other member that is then secured with the extension 80 to retain the valve member 90 within the extension 80. By assembling the valve assembly 24 (the valve member 90 and ring 92) through the proximal opening 84, there is a minimal likelihood of the valve member 90 from being forced out of the extension 80 during use. Once the valve assembly 24 is secured therewithin, the extension 80 is secured with the handle body portion 82.

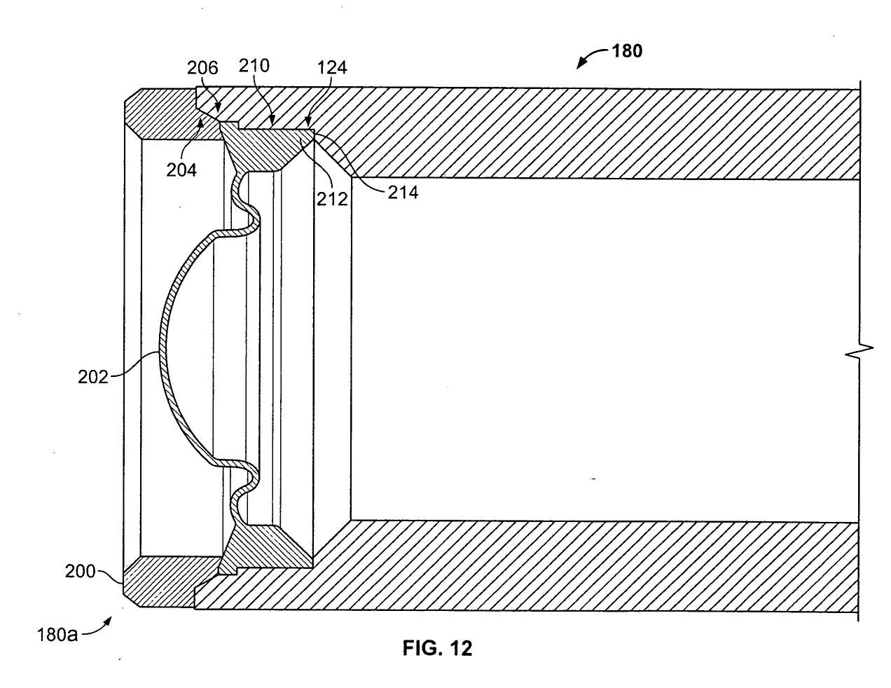

In an alternative form, an extension 180 is formed integrally with the handle body portion 82. Accordingly, a valve assembly 124 is assembled with the extension 180 from an extension distal end 180a, as shown in FIG. 12. The extension 180 includes an end cap 200 that is annular to provide access to a valve 202 of the valve assembly 124. The end cap 200 has structure 204 corresponding to structure 206 formed on the extension 180 so that they may be easily joined. Additionally, the joining of the end cap 200 and the extension 180 define a stepped annular groove 210. To assemble the extension 180, valve assembly 124, and end cap 200, a ring portion 212 of the valve assembly 124 is inserted into the extension 180 so that it abuts against a shoulder 214 formed on the annular groove 210. The end cap 200 is then fitted into the extension 180, as shown in FIG. 12, and finally secured there such as by ultrasonic welding. In this manner, there is little likelihood that the valve assembly 124 may become dislodged.

As best seen in FIG. 2, the handle 16 includes a central reservoir or cavity 110 for storing soap. The central cavity 110 is in fluid communication with the extension passageway 86 so that fluid such as soap may also be stored within the passageway 86 and so that the fluid within the cavity 110 may be directed through the passageway 86 for delivery to the sponge 30.

The valve member 90 is, as noted, a one-way valve. During operation, fluid may be forced through the valve member 90 from the extension 80 and the handle cavity 110. One-way valves are well-known and may be provided in a number of forms such as a cup-shape having one or more radial slits, or a single flap that is permitted to shift distally but restricted from shifting proximally beyond a closed position. Preferably, the valve member 90 is resiliently openable and has a natural bias to the closed position so that, when pressure within the cavity 110 is not significantly greater than the atmospheric pressure outside the wand 10, the valve member 90 automatically closes.

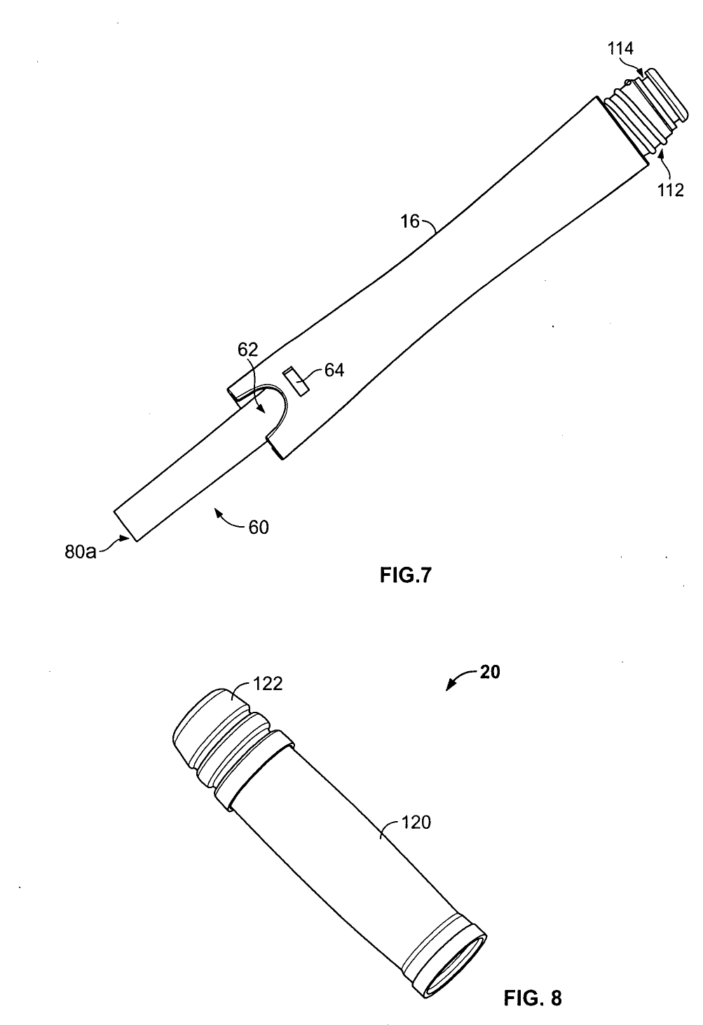

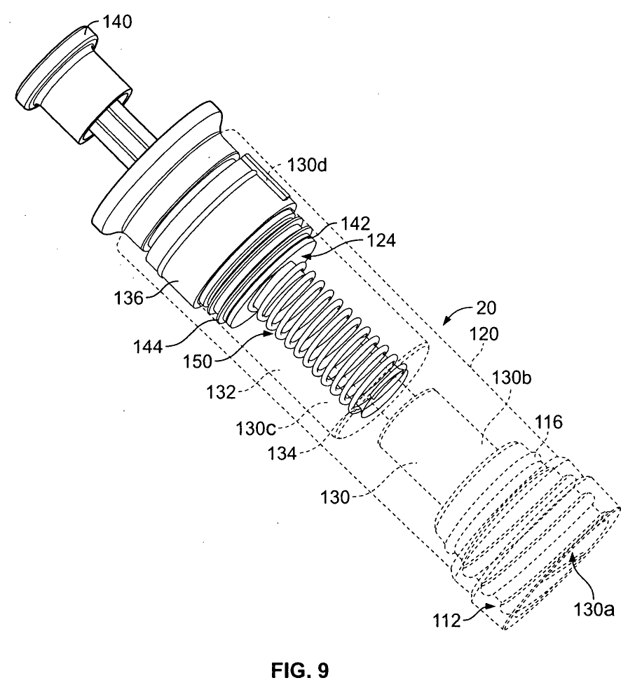

To access the handle cavity 110, the pump assembly 20 is removable from the handle 16. In the present form best seen in FIGS. 2 and 7, the pump assembly 20 and the handle 16 are provided with cooperating structure such as the depicted threads 112, though alternative structures such as a bayonet connection, a snap fit, or a friction fit may be provided therebetween. As can be seen in FIG. 7, the handle 16 also includes a groove 114 for receiving a seal 116 such as an O-ring (FIG. 9) which serves to minimize fluid flow (air or liquid) across the threads 112 and between the handle 16 and pump assembly 20.

Turning now to FIGS. 2 and 8-11, the pump assembly 20 is actuated to force fluid through the valve assembly 24 and to the sponge 30. The pump assembly 20 includes a pump body 120 that is generally rigid and may also provide a grip for a user. The threads 112 of the pump assembly 20 are formed on an interior portion of the pump body 120. In general terms, the pump assembly 20 includes a compressible pump bulb 122 that is depressed along the axis of the wand 10 to compress a piston 124 which forces the fluid to exit through the valve assembly 24.

In more specific terms, the pump body 120 defines an interior cavity 130 and passageway extending through the pump body 120. A first portion 130a of the cavity 130 includes the threads 112 and mates with the seal 116. A second portion 130b of the cavity 130 is reduced from the first portion 130a and is in fluid (pressure) communication with a third portion 130c of the cavity 130 that forms a piston cylinder 132. The piston cylinder 132 is enlarged from the second portion 130b so that a shoulder 134 is formed at their juncture. The cavity 130 further includes a fourth portion 130d for securing a piston guide 136 which itself slidably secures a piston member 138 (FIG. 11). The piston guide 136 may be snap fit or otherwise secured within the cavity fourth portion 130d.

As can be seen in FIG. 11, the piston member 138 includes an actuation end 140 which is contacted when the pump bulb 122 is depressed. This causes the piston member 138 to shift distally toward the sponge 30. The piston member 138 includes a piston head portion 142 positioned within piston cylinder 132, the head portion 142 having gaskets or ribs 144 (such as may be found on a syringe, for example) extending outwardly and contacting the piston cylinder 132. The ribs 144 prevent fluid from the cavity 110 and cylinder 132 from passing between the head portion 142 and cylinder 132. Therefore, the fluid generally is unable to reach the region between the pump bulb 122 and the actuation end 140. When the piston member 138 is actuated toward the sponge 30, the fluid (gas or liquid) within the piston cylinder 132 is forced into the cavity 116 so that fluid is forced to exit the wand 10 through the valve assembly 24. The piston member 138 is preferably a two-piece structure that is assembled through the piston guide 136. A return-bias member, preferably in the form of a coil spring 150, is provided between the piston member 138 and the shoulder 134 so that, after the piston member 138 has been actuated, release of the depression on the pump bulb 122 allows the spring 150 to return the piston member 138 generally to its original position. As the piston member 138 retracts, the one-way valve assembly 24 closes so that fluid is not drawn into the passageway 86 and the cavity 110 through the valve member 90.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A fluid-dispensing apparatus comprising:
an elongated portion including a cavity for storing cleaning fluid therewithin;
a cleaning medium carried by the body;
an opening in the body providing communication between the cavity and the cleaning medium;
an actuator mechanism for moving cleaning fluid from the cavity through the opening to the cleaning medium; and
a valve disposed at the opening and having an open position for permitting cleaning fluid to flow from the cavity through the opening and having a closed position for preventing fluid flow into the cavity through the opening.

2. The apparatus of claim 1 wherein the body includes a handle, the cavity being formed in the handle.

3. The apparatus of claim 1 wherein the actuator mechanism includes a pump assembly.

4. The apparatus of claim 3 wherein the pump assembly includes a piston moveable from a retracted position toward the opening to force soap from the cavity through the opening.

5. The apparatus of claim 4 wherein the pump assembly further includes a return-bias member for returning the piston toward the retracted position.

6. The apparatus of claim 3 wherein the pump assembly includes a compressible pump bulb depressible to advance the piston from the retracted position toward the opening.

7. The apparatus of claim 1 wherein the cleaning medium includes a sponge portion.

8. The apparatus of claim 1 wherein the body includes an elongated extending portion received within the cleaning medium.

9. The apparatus of claim 8 wherein the valve is located within the elongated extending portion, the elongated extending portion including the opening for permitting cleaning fluid to be dispensed and having an inlet in communication with the cavity for storing cleaning fluid, the valve having an outer portion for securing the valve, the outer portion being positioned between structures generally preventing movement of the outer portion relative to the extending portion.

10. The apparatus of claim 1 wherein the opening is closely positioned to the valve, and the opening is closely positioned to at least a portion of the cleaning medium.

11. The apparatus of claim 1 wherein the cleaning medium includes a brush portion.

12. The apparatus of claim 1 wherein the cleaning medium is removably secured with the body.

13. The apparatus of claim 1 wherein the actuator mechanism is removable to provide access to the cavity for filling the cavity with cleaning fluid to be dispensed.

14. The apparatus of claim 1 wherein the valve automatically closes when the actuator mechanism is released.

15. The apparatus of claim 1 wherein the valve automatically closes when the pressure within the cavity is no greater than the atmospheric pressure outside of the apparatus.

16. The apparatus of claim 1 wherein the body includes a valve-receiving portion which includes the opening for permitting cleaning fluid to be dispensed and has an inlet in communication with the cavity for storing cleaning fluid, the valve is located within the valve-receiving portion, the valve is disposed within a generally ring-like portion, and the ring-like portion is positioned between structures generally preventing movement of the ring-like relative to the extending portion.

17. An apparatus for dispensing fluid comprising:
an elongated body portion including a cavity for receiving fluid therein;
an opening in communication with the cavity for permitting the received fluid to be dispensed therefrom; and
an actuator mechanism including a piston cylinder, and a piston having a peripheral seal in contact with the piston cylinder, the piston movable in a first direction for directing fluid from the cavity through the opening and movable in a second direction opposite the first direction for drawing fluid into the cavity through the opening.

18. The apparatus of claim 17 further including a resilient compressible pump bulb secured over the piston.

19. The apparatus of claim 18 wherein the piston includes an extending portion manually actuatable, the pump bulb covering the extending portion.
